(19) United States
(12) Patent Application Publication
(10) Pub. No.: US 2004/0168490 A1
(43) Pub. Date: Sep. 2, 2004

(54) Extensible automobile lock

(76) Inventor: Hui-Hua Hsieh, Chung Ho City (TW)

Correspondence Address: Hui-Hua HSIEH, P.O. Box 90, Tainan City, 704, TW

(21) Appl. No.: 10/374,025

(22) Filed: Feb. 27, 2003

(51) Int. Cl. B60R 25/02

(52) U.S. Cl. 70/209

(57) ABSTRACT

An extensible automobile lock in the invention has a body, a receiving tube and a telescoping rod. The body has a receiving housing provided with a stop pin and a locating pin therein. When in use, the receiving tube and the telescoping rod can be pulled outwards to make their hooks hooked on an automobile steering wheel with the receiving tube stopped by the stop pin and engaged by the locating pin so as not to be withdrawn into or pulled outwards to slide off the body, thus achieving an effect of anti-theft. When not in use, only to rotate a lock core to be in an unlocked status to allow the telescoping rod to be slid back into the body to push the stop pin upwards to allow the receiving tube to be withdrawn into the body, thereby reducing the automobile lock to a minimum dimension convenient for storage.

### BACKGROUND OF THE INVENTION

1. Field of the Invention

This invention relates to an extensible automobile lock, particularly to one having a body, a receiving tube and a telescoping rod, in which the body has a receiving housing provided with a stop pin and a locating pin disposed therein. When in use, the receiving tube and the telescoping rod can be pulled outwards relative to the body to make their hooks respectively hooked on an automobile steering wheel with the receiving tube stopped by the stop pin and engaged by the locating pin so as not to be withdrawn into or pulled outwards to slide off the body, thus providing a secure lock on the automobile steering wheel to achieve an effect of anti-theft. When not in use, only to rotate a lock core of the body to be in an unlocked status to allow the telescoping rod to be slid back into the body to push the stop pin upwards so that an inserted end of the receiving tube is no longer stopped by the stop pin and capable of being withdrawn into the body, thereby reducing the automobile lock to a minimum dimension only occupying little space convenient for storage.

2. Description of the Prior Art

Generally speaking, as shown in FIG. 1, a known conventional automobile lock 1 mainly has a body 10 and a telescoping rod 11. The body 10 has a hook 100 formed thereon, a locking housing 101, a lock core 102 contained therein, and a passage 103 disposed therein. The telescoping rod 11 capable of being extended into the passage 103 of the body 10 has a hook 110 formed thereon in a direction opposite to the hook 100 of the body 10, and a plurality of annular grooves 111 formed thereon. When in use, the telescoping rod 11 can be pulled outwards relative to the body to make the hooks 100, 110 of the body 10 and the telescoping rod 11 respectively hooked on an automobile steering wheel to limit the rotation of the automobile steering wheel to achieve an effect of anti-theft. When not in use, the telescoping rod 11 can be withdrawn into the body 10 to shorten the length of the conventional automobile lock 1; however, the whole length of the conventional automobile lock 1 in a withdrawn status is still too long for storage and the dimension of the conventional automobile lock 1 occupies too much space inconvenient for carrying.

### SUMMARY OF THE INVENTION

The main purpose of the invention is to offer an extensible automobile steering convenient in operation and capable of being withdrawn to reduce its whole dimension convenient for storage.

The main feature of the invention is to provide an extensible automobile lock including:

a body having a locking housing, a hook formed thereon, a passage disposed therein, a receiving housing, a stop pin and a locating pin, the locking housing provided with a lock core contained therein, the receiving housing provided with a first through hole and a second through hole disposed therein and communicating with the passage, the stop pin disposed in the first through hole, a first spring placed on the stop pin, a first holding plate secured in the first through hole, the locating pin disposed in the second through hole, a second spring placed on the locating pin, a second holding plate secured in the second through hole;

a receiving tube capable of being extended into the passage of the body, and having an opening disposed therein and an engagement groove formed thereon; and,

a telescoping rod capable of being penetrated through the passage of the body and extended into the opening of the receiving tube, the telescoping rod having a plurality of annular grooves formed thereon and a hook formed at one end thereof.

### BRIEF DESCRIPTION OF DRAWINGS

This invention will be better understood by referring to the accompanying drawings, wherein:

FIG. 1 is a perspective view of a known conventional automobile steering wheel lock;

FIG. 2 is an exploded perspective view of an extensible automobile lock in the present invention;

FIG. 3 is a perspective view of the extensible automobile lock in the present invention, showing a telescoping rod and a receiving tube both being withdrawn in a body;

FIG. 4 is a sectional view of the extensible automobile lock in the present invention, showing the telescoping rod and the receiving tube both being withdrawn in the body;

FIG. 5 is a schematic view of the extensible automobile lock in the present invention, showing the receiving tube pulled outwards relative to the body;

FIG. 6 is a schematic view of the extensible automobile lock in the present invention, showing the telescoping rod and the receiving tube both pulled outwards relative to the body; and,

FIG. 7 is a perspective view of the extensible automobile lock in the present invention, showing the telescoping rod and the receiving tube both pulled outwards relative to the body.

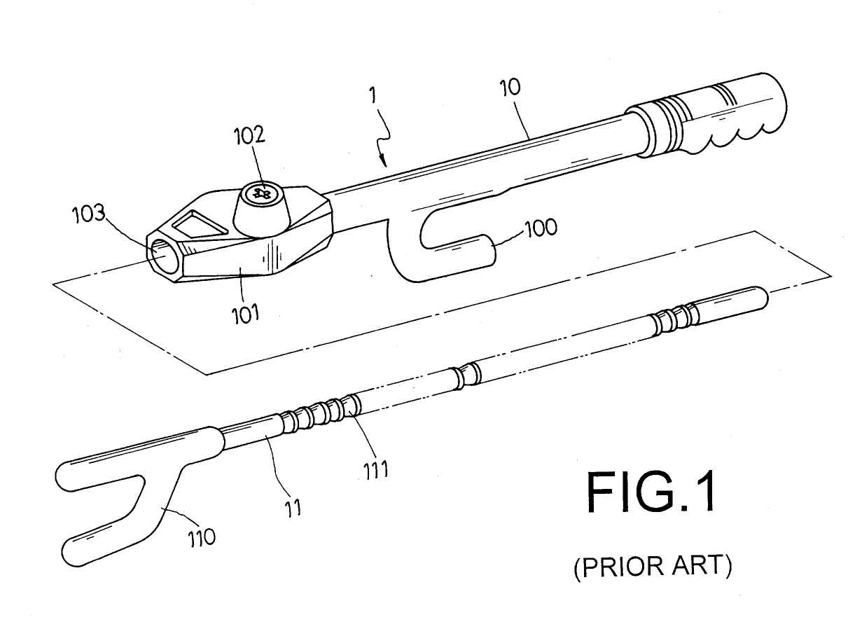

### DETAILED DESCRIPTION OF THE PREFERRED EMBODIMENT

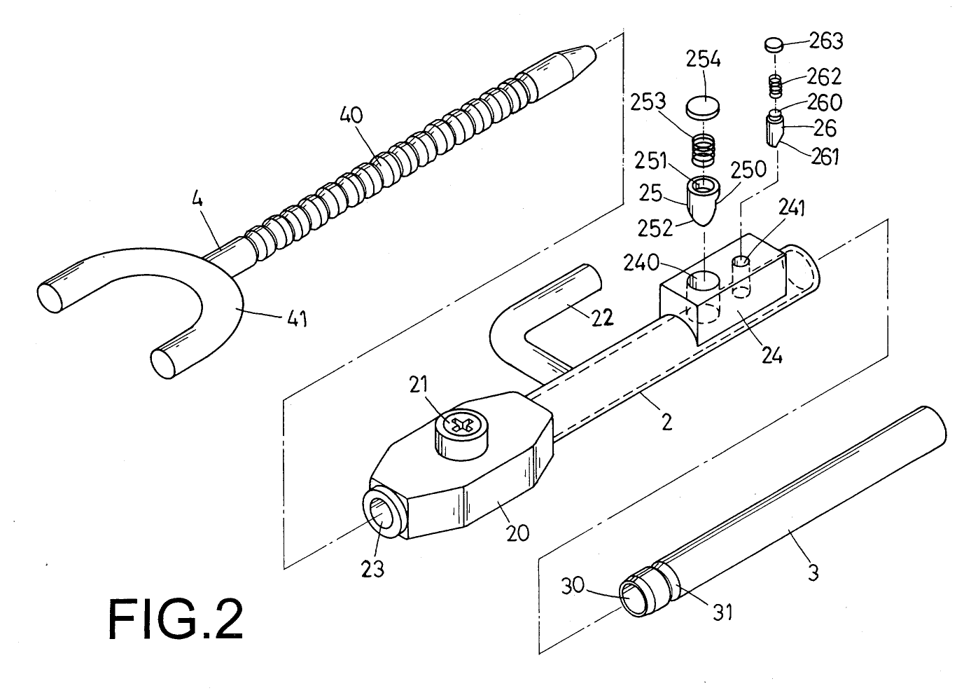

A preferred embodiment of an extensible automobile lock in the present invention, as shown in FIG. 2, mainly has a body 2, a receiving tube 3 and a telescoping rod 4.

The body 2 has a locking housing 20, a hook 22 formed thereon, a passage 23 disposed therein, a receiving housing 24, a stop pin 25 and a locating pin 26. The locking housing 20 is provided with a lock core 21 contained therein. The receiving housing 24 is provided with a first through hole 240 and a second through hole 241 disposed therein and communicating with the passage 23. The stop pin 25 is disposed in the first through hole 240 of the receiving housing 24, and has one sidewall provided with a cut face 250, a top provided with a recess 251, and a bottom designed to be a conic surface 252. A first spring 253 placed on the recess 251 of the stop pin 25. A first holding plate 254 is secured in the first through hole 240 of the receiving housing 24. The locating pin 26 is disposed in the second through hole 241 of the receiving housing 24, and has a top provided with a projection 260 and a bottom provided with a sloped surface 261. A second spring 262 is sleeved on the projection 260 of the locating pin 26. A second holding plate 263 is secured in the second through hole 241 of the receiving housing 24.

The receiving tube 3 capable of being extended into the passage 23 of the body 2 has an opening 30 disposed therein and an engagement groove 31 formed near one end thereof.

The telescoping rod 4 capable of being penetrated through the passage 23 of the body 2 and extended into the opening 30 of the receiving tube 3 has a plurality of annular grooves 40 formed thereon and a hook 41 formed at one end thereof.

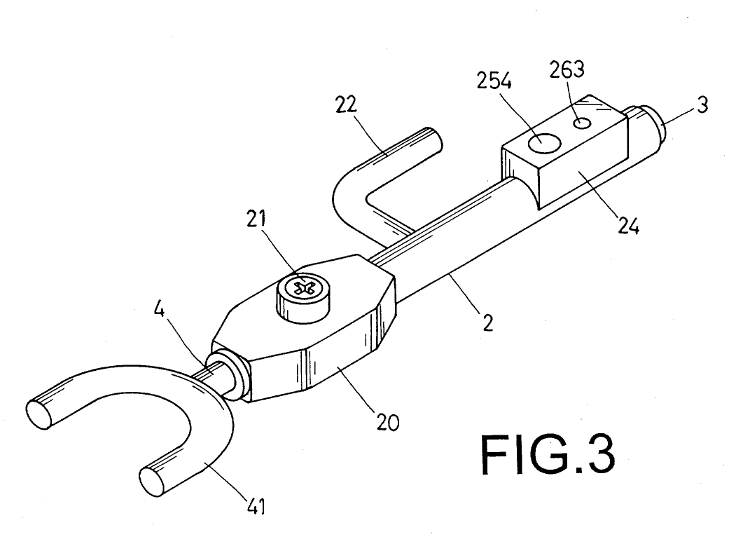

In assembling, referring to FIGS. 2, 3 and 4, firstly extend the receiving tube 3 into the passage 23 of the body 2. Secondly, insert the stop pin 25 and the first spring 253 into the first through hole 240 of the receiving housing 24, and then fittedly mount the first holding plate 254 in the first through hole 240 to make the stop pin 25 and the first spring 253 confined within the first through hole 240. Thirdly, insert the locating pin 26 and the second spring 262 in the second through hole 241 of the receiving housing 24, and then fittedly mount the second holding plate 263 in the second through hole 241 to make the locating pin 26 and the second spring 262 confined within the second through hole 241. Finally, penetrate the telescoping rod 4 through the passage 23 of the body 2 and further extend the telescoping rod 4 into the opening 30 of the receiving tube 3, by which an assemblage of the whole structure of the extensible automobile lock in the present invention is completed.

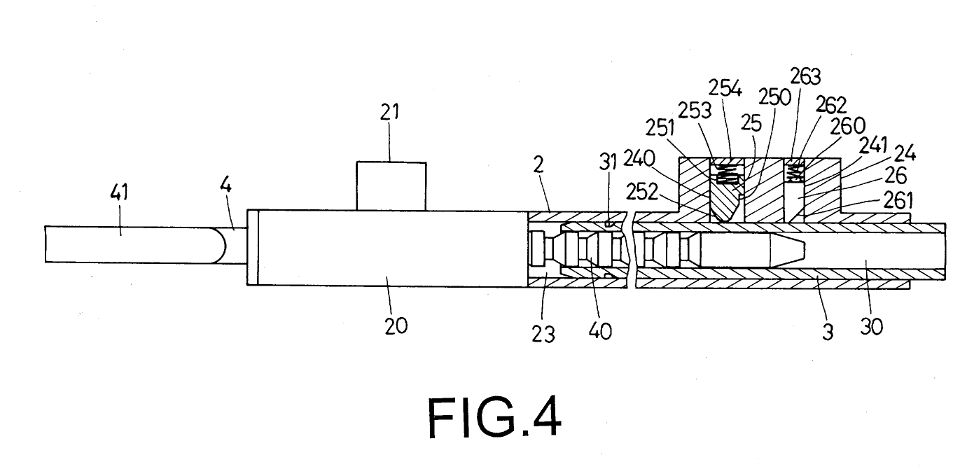

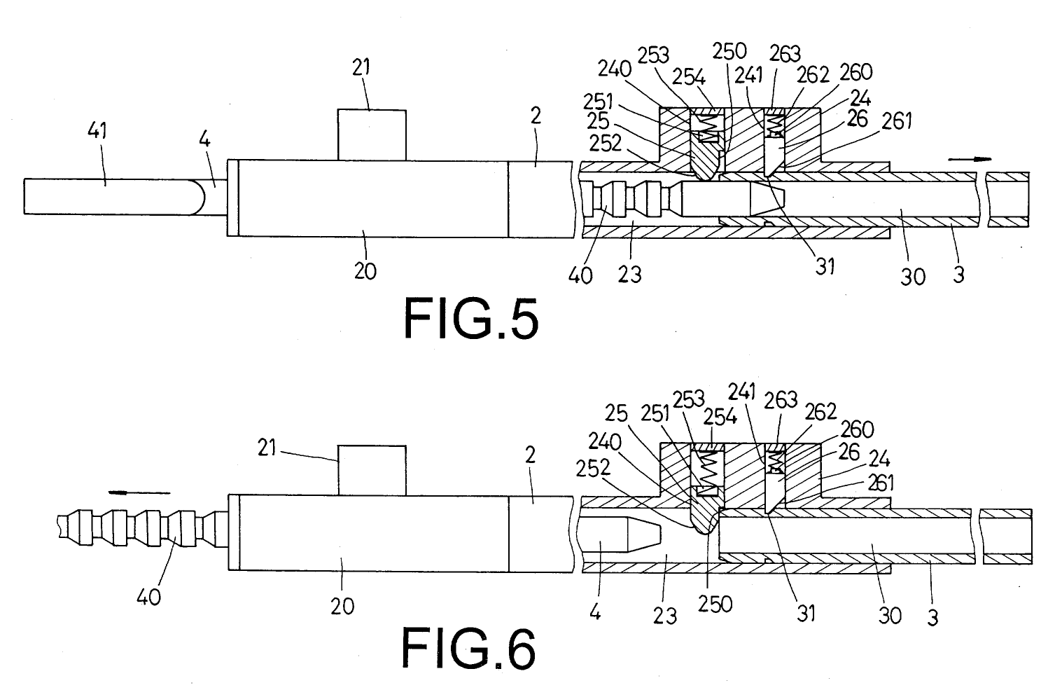

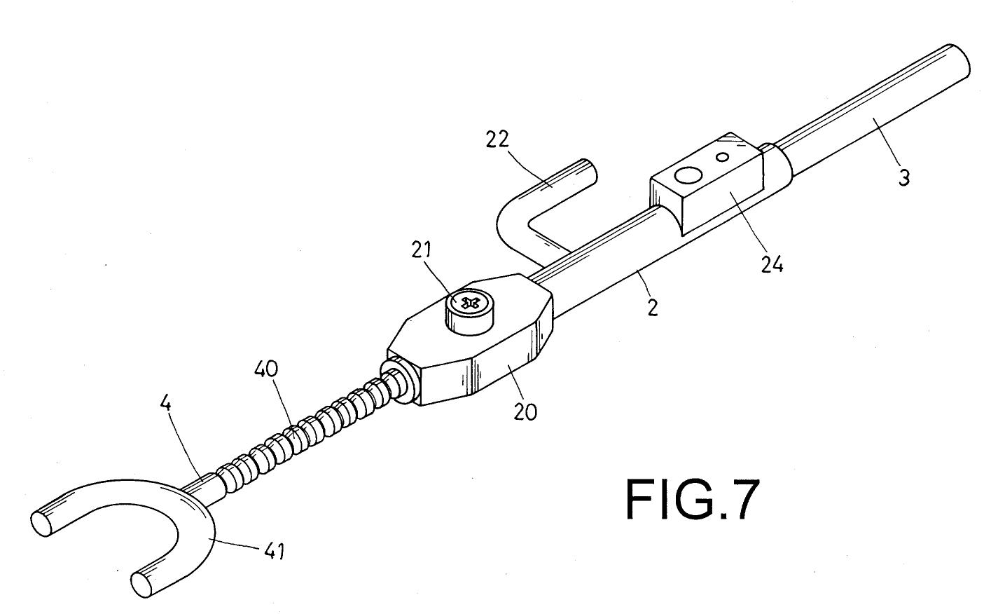

When the extensible automobile lock of the present invention is applied on an automobile steering wheel, referring to FIGS. 4, 5, 6 and 7, firstly pull the receiving tube 3 outwards relative to the body 2, as shown in FIG. 5, to make a lower end of the locating pin 26 engaged in the engagement groove 31 of the receiving tube 3 so as to hold the receiving tube 3 in place without being pulled outwards further. At this time, the stop pin 25 no longer retained against by a circumferential wall of the receiving tube 3 is urged by the resilience of the first spring 253 to descend and press against a circumferential wall of the telescoping rod 4. Secondly, hook the hook 22 of the body 2 on the automobile steering wheel. Thirdly, pull the telescoping rod 4 outwards relative to the body 2, as shown in FIG. 6, to make the hook 41 of the telescoping rod 4 hooked on the automobile steering wheel. At this time, the stop pin 25 no longer retained against by an inserted end of the telescoping rod 4 is urged by the resilience of the first spring 253 to descend and make an inserted end of the receiving tube 3 stopped by the cut face 250 of the stop pin 25 without being withdrawn into the body 2, by which the present invention is capable of locking the automobile steering wheel securely to limit the rotation of the automobile steering wheel, thus achieving an effect of anti-theft and being very convenient in use.

When not in use, firstly use a key to rotate the lock core 21 of the body 2 to be in an unlocked status, and then slide the telescoping rod 4 back into the passage 23 of the body 2 to make the inserted end of the telescoping rod 4 push the conic surface 252 of the stop pin 25 to forcedly move the stop pin 25 upwards to compress the first spring 253, by which the inserted end of the receiving tube 3 is no longer stopped by the cut face 250 of the stop pin 25, as shown in FIG. 5, and can be withdrawn into the body 2 with the stop pin 25 and the locating pin 26 pushed upwards and retained against by the receiving tube 3. At the same time, the telescoping rod 4 is capable of being extended into the opening 30 of the receiving tube 3, thereby permitting the extensible automobile lock of the present invention to be withdrawn to a minimum dimension only occupying little space convenient for storage.

While the preferred embodiment of the invention has been described above, it will be recognized and understood that various modifications may be made therein and the appended claims are intended to cover all such modifications that may fall within the spirit and scope of the invention.

What is claimed is:

1. An extensible automobile lock comprising:
a body having a locking housing, a hook formed thereon, a passage disposed therein, a receiving housing, a stop pin and a locating pin, said locking housing provided with a lock core contained therein, said receiving housing provided with a first through hole and a second through hole disposed therein and communicating with said passage, said stop pin disposed in said first through hole, a first spring placed on said stop pin, a first holding plate secured in said first through hole, said locating pin disposed in said second through hole, a second spring placed on said locating pin, a second holding plate secured in said second through hole;
a receiving tube capable of being extended into said passage of said body, and having an opening disposed therein and an engagement groove formed thereon;
a telescoping rod capable of being penetrated through said passage of said body and extended into said opening of said receiving tube, said telescoping rod having a plurality of annular grooves formed thereon and a hook formed at one end thereof; and,
whereby when in use, said receiving tube and said telescoping rod are capable of being pulled outwards relative to the body to make said hooks of said body and said telescoping rod respectively hooked on an automobile steering wheel with said receiving tube stopped by said stop pin and engaged by said locating pin so as to be held in place without being withdrawn into or pulled outwards to slide off said body, thus providing a secure lock on said automobile steering wheel to achieve an effect of anti-theft; when not in use, only to rotate said lock core of said body to be in an unlocked status to allow said telescoping rod to be slid back into said body to push said stop pin upwards so that an inserted end of said receiving tube is no longer stopped by said stop pin and capable of being withdrawn into said body, thereby reducing said automobile lock to a minimum dimension only occupying little space convenient for storage.

2. The extensible automobile lock as claimed in claim 1, wherein said stop pin has one sidewall provided with a cut face, a top provided with a recess, and a bottom designed to be a conic surface.

3. The extensible automobile lock as claimed in claim 1, wherein said locating pin has a top provided with a projection, and a bottom provided with a sloped surface.
